(19) United States
(12) Patent Application Publication
(10) Pub. No.: US 2026/0081842 A1
(43) Pub. Date: Mar. 19, 2026

(54) PROXIMITY, LOCALITY, INTENT-BASED TENSOR OPTIMIZED WORKLOAD PLACEMENT METHOD AND APPARATUS

(71) Applicant: VERIZON PATENT AND LICENSING INC., Basking Ridge, NJ (US)

(72) Inventors: Lap TSE, Marietta, GA (US); David TAFT, Keller, TX (US); Peter B. SENSENBRENNER, North Richland Hills, TX (US)

(73) Assignee: VERIZON PATENT AND LICENSING INC., Basking Ridge, NJ (US)

(21) Appl. No.: 18/890,334

(22) Filed: Sep. 19, 2024

(51) Int. Cl. H04L 41/122; G06F 9/455

(52) U.S. Cl. CPC H04L 41/122; G06F 9/455; G06F 2009/45595

(57) ABSTRACT

Techniques for packet flow description (PDF) management are disclosed. In one embodiment, a method is disclosed comprising obtaining, by an application function (AF), information about network functions (NFs) instantiated as virtual machines (VMs) on compute resources of a cloud platform, obtaining, by the AF, information about the compute resources, obtaining, by the AF, information about a plurality of UEs accessing the NFs, and using, by the AF, the information about the NFs, compute resources of the cloud platform and the plurality of UEs to make an assessment of a workload placement corresponding to the NFs instantiated on the compute resources of the cloud platform.

### BACKGROUND INFORMATION

A communications network, such as a 3GPP (3^{rd} Generation Partnership Project) 5G (Fifth Generation) communications network, can include a radio access network, such as the new Radio Network (NG-RAN), and 5G Core network functions (NFs) that each offer one or more services to other NFs in the network. Using a Service Based Architecture (SBA), NFs of the 5G network can communicate using a Service Based Interface (SBI), such that a NF acting as a service producer can provide services to another NF acting as a service consumer via the SBI. The NFs of the 5G network can be implemented as software applications deployed over a number of cloud data centers. Typically, a cloud data center contains a number of commercial-off-the-shelf (COTS) servers, data storage devices and network equipment. In this scenario, virtual machines (VMs), such as containerized, cloud native network functions (CNF), virtualized network functions (VNFs) and the like, instantiated on COTS servers or other computing devices are used to instantiate NFs that can process packets and provide services to instances of user equipment (UE) accessing the 5G network.

### BRIEF DESCRIPTION OF THE DRAWINGS

FIG. 1 provides an example of an exemplary 5G network architecture including a workload placement application function and a tensor mediation plane in accordance with one or more embodiments of the present disclosure;

FIG. 2 provides an example illustrating components and interactions of a workload placement application function in accordance with one or more embodiments of the present disclosure;

FIG. 3 provides a workload placement optimization process flow in accordance with one or more embodiments of the present disclosure.

FIG. 4 provides some examples of workload placement optimization scenarios in accordance with one or more embodiments of the present disclosure;

FIG. 5 provides an example of an overload relief call flow in accordance with one or more embodiments of the present disclosure; and

FIG. 6 provides a block diagram illustrating a computing device showing an example of client or server device used in accordance with one or more embodiments of the present disclosure.

### DETAILED DESCRIPTION OF EXAMPLE EMBODIMENTS

Techniques for optimized workload placement are disclosed. Disclosed embodiments can be used to match the service requirements of each packet with the network resources, such as without limitation the COTS hardware of a cloud data center, that is best suited to process those packets. Disclosed embodiments provide a Proximity, Locality, Intent Optimized Workload Placement (or PLIOP) application function (AF), or simply AF, which uses a tensor mediation plane (TMP), and is configured to manage and optimize workload placement using a combination of logical control plane awareness and physical hardware attribute awareness.

For control plane function awareness, the AF can access information about control plane NFs via the Service Based Interface (SBI) used by the NFs to intercommunicate. The AF can use the SBI to receive information from and/or about the NF. AF 104 can use the obtained NF information to manage the workload of the NFs.

The NFs of a 5G network can be virtualized—i.e., implemented as software executing on the COTS hardware of a cloud platform. The TMP comprises agents (e.g., micro services) that execute on the COTS hardware that executes the virtualized NFs, or VNFs. The TMP can comprise an application programming interface (API) or other type of interface enabling the AF to communicate with the agents. The AF can use the agents executing on the COTS hardware to gain an awareness of the hardware that is executing the VNFs. A TMP agent executing on a computing device (e.g., server, server blade, virtualized server, etc.) can forward information to the AF that can be used by the AF in workload optimization and management. Embodiments of the present disclosure are described in connection with server blades. It should be apparent that embodiments of present disclosure can be used with any type of actual/physical and/or virtual computing devices.

In a conventional approach, UE service requests are not matched with the COTS hardware best suited to process the requests. For example, using a conventional approach, premium low latency MEC-based service request (e.g., a request to access a network gaming service) with high-volume, low-latency signaling and processing requirements can be processed by the same COTS server blades as another service request (e.g., a social media service request) that typically does not have the same high-volume and low latency expectations. In addition, conventional approaches fail to consider the space, power and cooling limitations of the COTS hardware when assigning workload.

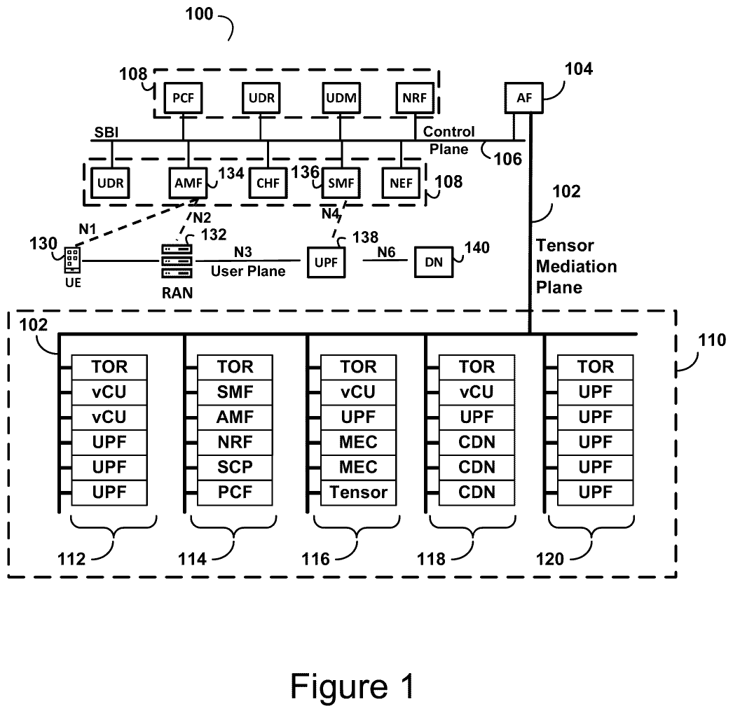

FIG. 1 provides an example of an exemplary 5G network architecture comprising the AF and TMP in accordance with one or more embodiments of the present disclosure. In example 100 shown in FIG. 1, AF 104 can be in communication with agents of TMP 102 executing at each server blade of cloud platform 110. By way of a non-limiting example, cloud platform 110 can comprise a number of COTS hardware.

In accordance with embodiments of the present disclosure, AF 104 has user plane and control plane awareness. In addition, AF 104 can use TMP 102 to monitor physical hardware attributes. AF 104 can then combine its user plane and control plane awareness with an awareness of the COTS hardware of cloud platform 110 to dynamically place workloads in an optimized manner to minimize power, space, and cooling issues while maximizing service performance and network metrics.

By way of a further non-limiting example, the server blades of cloud platform 110 can be grouped using a top-of-rack (TOR) architecture, end-of-rack, or other architecture. In a TOR architecture, which is shown in example 100 of FIG. 1, each rack of servers can have a generalized TOR router configured to communicate with other server racks. While a TOR architecture is shown in example 100, it should be apparent that embodiments of the present disclosure can be performed using any type of hardware configuration, including a configuration in which some or all of the server blades are not grouped.

In example 100, each server rack 112, 114, 116, 118 and 120 can comprise hardware having certain hardware attributes suited for a certain type of service, or certain types of services. By way of some non-limiting examples, server rack 112 can comprise high performance hardware suitable for high-speed packet processing, such as and without limitation might be needed for user plane packet processing, server rack 114 can comprise hardware suitable for handling communications between NFs (e.g., without limitation, SBI, Hypertext Transport Protocol (HTTP) 2.0, etc. communications among 5G core network functions), server rack 116 can comprise hardware suitable for handling services requiring low latency, ultra-reliable low latency, etc. communications and processing, server rack 118 can comprise hardware well suited for storage, video streaming and the like, and server rack 120 can comprise hardware suitable for handling low-level performance service requirements (e.g., Internet of Things (IoT) applications, service oversubscriptions, etc.).

Although not shown in example 100, AF 104 can be instantiated by cloud platform 110, such that AF 104 is executed by one or more server blades of cloud platform 110.

Access and mobility management function (AMF) 134 and session management function (SMF) 136 are functions of control plane 108. Other NFs of control plane 108 shown in example 100 include policy control function (PCF), user data repository (UDR), unified data management (UDM), network repository function (NRF), charging function (CHF) and network exposure function (NEF). As discussed, AF 104 can communicate with NFs, e.g., control plane 108 NFs, UPF 138, Service Communication Proxy (SCP), and the like, via SBI 106.

In example 100, cloud platform 110 can be configured to service a number of instances of user equipment (UE) 130. Examples of UE 130 include without limitation mobile phones, tablets, laptops, gaming devices, sensors, IoT devices, autonomous machines, wired devices, wireless handsets, and any other devices equipped with a cellular or wireless or wired transceiver.

As shown in example 100, UE 130 can access the 5G network via radio access network (RAN) 132. AMF 134 interacts with RAN 132 via an N2 interface and interacts with UE 130 via an N1 interface. AMF 134 relays session management-related communications to SMF 136 via SBI 106. SMF 136 can set up and manage connectivity of UE 130 with data network (DN) 140. SMF 136 can interact with and control user plane function (UPF) 138 via an N4 interface. UPF 138 can process and forward user data to DN 140 via interface N6. Data can be transported between RAN 132 and UPF 138 via interface N3. Data can be transported between UE 130 and DN 140 via UPF 138 and interface N6.

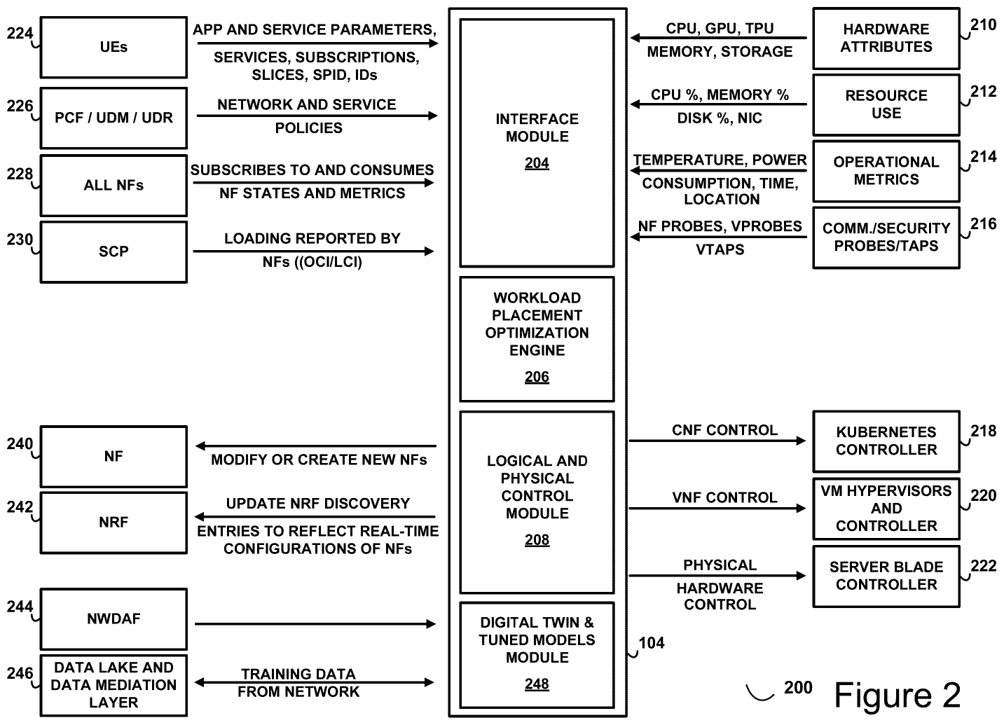

FIG. 2 provides an example illustrating AF components and interactions in accordance with one or more embodiments of the present disclosure. In example 200 shown in FIG. 2, AF 104 includes interface module 204, workload placement optimization engine 206, logical and physical control module 208, and digital twin and tuned call models module 248.

Interface module 204 of AF 104 can interface with control plane functions 108 and the server blades of cloud platform 110. Interface module 204 can include TMP 102 comprising agents running on each server blade of cloud platform 110. In accordance with one or more embodiments, AF 104 can communicate with an agent executing on a server blade of cloud platform 110 to retrieve information about the server blade, including hardware attributes 210 of the device, resource use 212 information, operational metrics 214, and network security and traffic information from sources 216 such as and without limitation cloud network probes, such as and without limitation network probes (or NF probes), virtual probes (or vprobes), taps and the like.

Interface module 204 of AF 104 can interface with control plane functions 108 via SBI 106. In accordance with one or more embodiments, interface module 204 of AF 104 can interface with various control plane functions 108, such as and without limitation, AMF 134, SMF 136, UDR, UDM, PCF and the like, to obtain information about UEs 224. Some non-limiting examples of UE information include application and service parametric information, services, subscriptions, slices, service profile identifier (SPID), and user identification information.

Interface module 204 of AF 104 can use SBI 106 to interface with NFs 228 (e.g., control plane NFs 108), PCF, UDM and UDR NFs 226 and SCP 230. AF 104 can use interface module 204 to subscribe to and consume information from NFs 228, such as and without limitation state and operational metric information of NFs 228. AF 104 can use interface module 204 to interface with SCP 230 to retrieve loading reported by NFs, such as and without limitation load status information including overload control information (OCI) and load control information (LCI).

AF 104 can use workload placement optimization engine 206 to optimize placement of work performed by NFs. AF 104 can instantiate, or create, new NFs, modify the work being performed by an existing NF 240, and the like. As discussed herein, AF 104 can use information obtained using interface module 204 to optimize placement of the workload performed by the NFs. AF 104 can update the profile of NF 240 in NRF 242 to reflect any modifications, creations, etc. made by AF 104 to NFs 240.

AF 104 can use logical and physical control module 208 of AF 104 to interface with Kubernetes controller 218 to manage (e.g., define and refine) containerized cloud-native network functions (CNFs) specifications, interface with VM Hypervisors and controller 220 to manage virtual network functions (VNFs) (e.g., define and refine) specifications, and interface with server blade controller 222 to control the physical hardware of cloud platform 110.

AF 104 can use module 248 to retrieve analytics, such as and without limitation analytics about UEs, services, and network load and performance information from NWDAF 244. In addition, module 248 of AF 104 can use the analytics to dynamically determine demand for services by UEs, network activity levels/volumes, etc. Module 248 can use the dynamically determined demand information to dynamically define new call models or refine existing call models, where such call models can be used to generate deployment models. A call model can include information indicating the number of UEs being serviced, services supported, traffic supported (e.g., low-latency gaming, low-resolution video streaming, high-resolution video streaming, social networking, etc.) and the like. AF 104 can use the generated deployment models to deploy cloud platform 110 hardware, or compute resources, based on the determined demand.

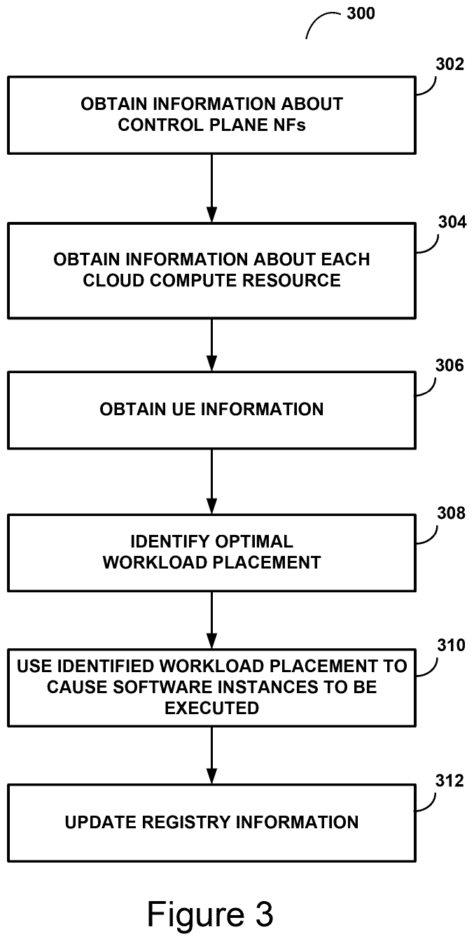

FIG. 3 provides a workload placement optimization process flow in accordance with one or more embodiments of the present disclosure. Process flow 300 of FIG. 3 uses information obtained by AF 104 using module 204 to optimize placement of workload with compute resources of platform 110.

At step 302, information about control plane NFs can be obtained. Step 302 can be performed by interface module 204 of AF 104. By way of a non-limiting example, AF 104 can subscribe to, or otherwise interface with, NFs of control plane 108 to obtain information about each NF of control plane 108, such as and without limitation information about each NF's current state, logical and physical location, network activities, OCI/LCI loads and congestion levels, etc.

At step 304, information about each cloud compute resource can be obtained. Step 304 can be performed by interface module 204 of AF 104. By way of a non-limiting example, AF 104 can use TMP 102 comprising an agent executing on each server blade of cloud platform 110 to obtain information about each server blade. By way of some non-limiting examples, a server blade's information can include hardware attributes 210, such as and without limitation whether the device's processing unit is for general-purpose processing (e.g., a CPU), graphics processing (e.g., a GPU), tensor processing (e.g., TPU), etc. By way of some further non-limiting examples, the cloud platform 110 hardware information can further include resource usage information 212, operational metrics 214 and network communications and security information from sources 216.

At step 306, UE information can be obtained. Step 306 can be performed by interface module 204 of AF 104. By way of a non-limiting example, AF 104 can interface with various control plane functions 108, such as and without limitation, AMF 134, SMF 136, UDR, UDM, PCF and the like, to obtain information about UEs 224. Some non-limiting examples of UE information include application and service parametric information, services, subscriptions, slices, service profile identifier (SPID), and user identification information.

At step 308, an optimal workload placement can be identified. Step 308 can be performed by workload placement optimization engine 206 of AF 104. By way of a non-limiting example, AF 104 can use the information obtained at steps 302, 304 and 306 to identify which server blade of cloud platform 110 to allocate for each NF, application, etc. needed for the service(s) being requested by each UE. In accordance with one or more embodiments, AF 104 can use the information obtained at steps 302, 304 and 306 to make an assessment of a workload placement corresponding to the NFs instantiated on the compute resources of cloud platform 110.

At step 310, the identified workload placement can be used to cause software instances to be instantiated on hardware of cloud platform 110. Step 308 can be performed by logical and physical control module 208 of AF 104. By way of a non-limiting example, module 208 can instruct controller 222 to instantiate each software instance identified by AF 104 on a server blade identified by AF 104 in accordance with the optimized workload placement identified by AF 104. In accordance with one or more embodiments, the instantiated NFs can be virtual machines, CNFs, VNFs, etc.

In accordance with one or more embodiments, at step 310, AF 104 can update a current workload placement corresponding to the NFs instantiated on the compute resources of cloud platform 110 based on the assessment of the current workload placement made by the AF 104, at step 308.

At step 312, registry information can be updated to reflect any change to the workload placement made by AF 104. Step 312 can be performed by module 208 of AF 104. By way of a non-limiting example, module 208 can update NRF 242 to reflect any changes to any existing NFs and to register any new NFs.

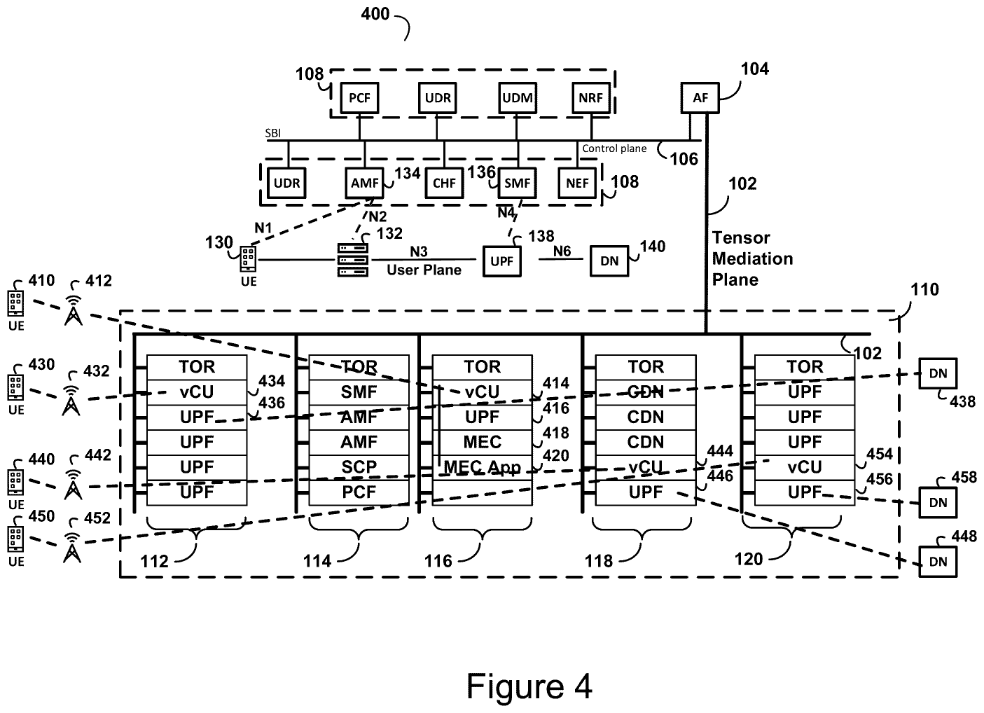

FIG. 4 provides some examples of workload placement optimization scenarios in accordance with one or more embodiments of the present disclosure. UEs 410, 430, 440 and 450 can each be accessing the 5G network via RAN 132. In example 400, UE 410 can be accessing RAN 132 via base station 412 (e.g., a gNodeB), UE 430 can be using base station 432, UE 440 can be using base station 442 and UE 450 can be using base station 452.

UE information 224 obtained by AF 104 about UE 410 can be used by AF 104 to determine that the service being requested by UE 410 involves access to a MEC-based application. Service and policy information obtained from NFs 226 by AF 104 can indicate that the MEC-based application requested by UE 410 is suited for new hardware provided by server rack 116, which can accommodate the low-latency requirements of the MEC-based application. Hardware attributes 210 information obtained by AF 104 indicates that server rack 116 includes at least one server blade capable of handling the MEC-based application requested by UE 410.

In addition to hardware attributes 210, AF 104 can use resource use 212 information, operational metrics 214 information and network communications and security information obtained from sources 216 to determine that server rack 116 includes at least one server blade suited for instantiating the NFs, MEC AF and MEC application software responsive to the UE's service request. By way of some non-limiting example, AF 104 can determine that server rack 116 has compute resources (e.g., CPU, memory, storage and NIC) currently available that are sufficient to handle the service requested by UE 410.

AF 104 can use module 208 to either create one or more new NFs 240 or modify one or more existing NFs 240 to handle the requested MEC-based application service request and to register each new and/or modified NF with NRF 242. In addition, module 208 can cause server blade controller 222 to instantiate virtualized centralized unit (vCU) 414, UPF 416, MEC AF 418 and MEC application 420 on one or more server blades of rack 116 to handle the MEC application service requested by 410.

In example 400, vCU 414 can be used as a base station software component of base station 412 that can receive signals from UE 410, process received signals and transmit signals to UE 410. UPF 416 can handle user plane functionality and MEC AF 418 can interface with MEC application 420 that provides the MEC-based application functionality requested by UE 410.

UEs 430, 440 and 450 are each requesting access to a service available via data network 140. UE 430 is requesting access to a network gaming service (e.g., Xbox® network), UE 440 is requesting access to a video streaming service (e.g., Netflix®) and UE 450 is requesting access to a social media service (e.g., Instagram®).

In response to the network gaming service request from UE 430, AF 104 determines that a computing device capable of providing low-latency operations (e.g., execution and network communications) is best suited to handle the request. AF 104 identifies at least one server blade on server rack 112 that has the low-latency computing capabilities to execute vCU 434 and UPF 436 in response to the network gaming service request from UE 430. In addition to having suitable hardware attributes 210, AF 104 can determine that resource use 212 information indicates that the identified server blade(s) have enough resource capacity to handle the request, that operational metric 214 information is acceptable and the networking capabilities of the identified hardware, determined using information 216, can handle the low-latency communications suited for the network gaming service being requested. In addition to vCU 434 used for signaling with UE 430, UPF 436 can handle IP data traffic between UE 430 and DN 438 providing the network gaming service requested by UE 430.

In response to the video streaming service request from UE 440, AF 104 determines that a computing device capable of optimizing video streaming and storage is best suited to handle the request. AF 104 identifies at least one server blade on server rack 118 to execute vCU 444 and UPF 446 in response to the video streaming request from UE 440. In addition to having suitable hardware attributes 210, AF 104 can determine that resource use 212 information indicates that selected server blade(s) have enough resource capacity to handle the request, that operational metric 214 information is acceptable, and no security or networking issues exists based on information 216. In addition to vCU 444 used for signaling with UE 440, UPF 446 can handle IP data traffic between UE 440 and DN 448 providing the video streaming service requested by UE 440.

In response to the social media service request from UE 450, AF 104 determines that a server blade from service rack 120, which includes lower cost hardware can be used to handle the request. AF 104 identifies at least one server blade with available compute resources on server rack 120 to execute vCU 454 and UPF 456 in response to the social media request from UE 450. In addition to vCU 454 used for signaling with UE 450, UPF 456 can handle IP data traffic between UE 450 and DN 458 providing the social media service requested by UE 450.

In accordance with one or more embodiments, AF 104 can monitor existing workload placements using information obtained by interface module 204 and to determine whether any modifications to the workload placements are necessary and to make any changes to the existing workload placements in order to optimize the workload placements.

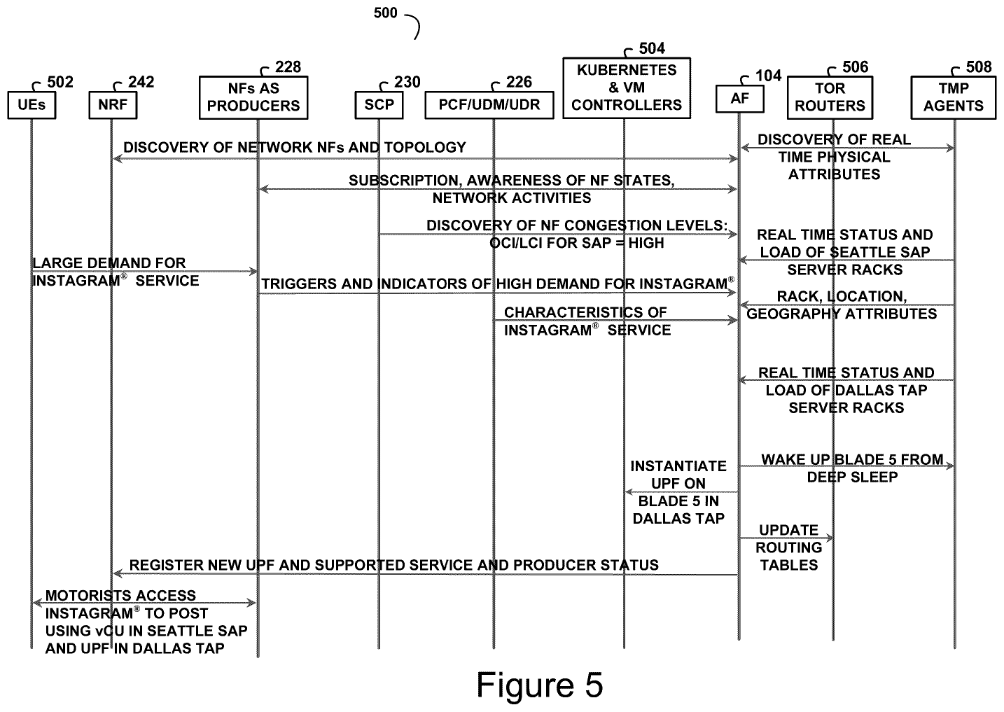

FIG. 5 provides an example of an overload relief call flow in accordance with one or more embodiments of the present disclosure. In example 500, the call flow provides an example of interaction of AF 104 with NFs and server blades of cloud platform 110 to modify workload placements.

AF 104 is monitoring resource use 212 and operational metrics 214 of hardware located at each hardware site, including at a service aggregation point (SAP) located at a hardware site in Seattle, WA and a telecom access point (TAP) located at a hardware site in Dallas, TX. In example 500, there is a large demand on NFs 228 as producers for the Instagram® service. By way of a non-limiting example, the large demand can be from motorists posting videos of bumper-to-bumper traffic caused by a bridge closure near the Seattle SAP's geographic location during rush hour.

In accordance with embodiments of the present disclosure, information obtained by module 204 of AF 104 alerts AF 104 of the issue and module 208 of AF 104 is able to reassign workload from the Seattle SAP to address the issue.

NFs 228 can provide triggers and indicators of the high demand for Instagram® service to AF 104 via module 204. Module 204 can subscribe to and consume information about NFs 228, such as and without limitation state and operational metric information of NFs 228. SCP 230 can provide loading information reported by NFs 228, such as and without limitation load status information including overload control information (OCI) and load control information (LCI) to AF 104 via module 204.

Interface module 204 of AF 104 can interface with TMP agents 508 executing on server blades executing NFs 228 to obtain resource information, such as resource use 212 information and operational metrics 214, indicating that the Seattle SAP's hardware executing NFs 228 is being overtaxed by the demand from the UEs 502. TMP agents 508 executing on each of the server blades at the Seattle SAP can provide attributes 210, resource use 212, operational metrics 214, etc. information. Operational metrics 214 provide time and geographic location information. By way of some non-limiting examples, geographic location information can include server rack identification and location information and geographic location attribute information. AF 104 can obtain such information from other sites, including the Dallas TAP.

Using the information obtained by module 204, AF 104 can detect that a problem exists in connection with the Seattle SAP hardware using information obtained from NFs 228, SCP 230 and information obtained from TMP agents 508 executing on the Seattle SAP's hardware. By way of some non-limiting examples, the obtained information can indicate that the hardware at the Seattle SAP is registering significantly increased resource use 212 with corresponding concerning increases in operational metrics 214.

AF 104 can use NRF 242 to discover network NFs and network topology. AF 104 can obtain information about the characteristics of the Instagram® service from PCF/UDM/UDR 226.

AF 104 is also receiving information about cloud platform 110 hardware located at other geographic locations. By way of a non-limiting example, from information received from a telecom access point (TAP) located in Dallas, TX, a sever blade, e.g., server blade 5, resident at the Dalla TAP has unused resources and a capacity to take on workload from the Seattle SAP.

Engine 206 of AF 104 can use information obtained from source 226 about Instagram® to determine that server blade 5 at the Dallas TAP is capable of handling the user plane functionality needed for Instagram®. By way of a non-limiting example, like the server blade at the Seattle SAP currently instantiating NFs 228, server blade 5 at the Dallas TAP can be a low-cost server capable of instantiating at least some of the NFs 228.

In example 500, module 208 of AF 104 can wake up blade 5 from a deep sleep, instruct one or more of controllers 504 to instantiate a UPF NF on server blade 5 in the Dallas TAP, update routing tables of TOR routers 506 and register the new UPF and supported service and producer status information with NRF 242. UEs 502 can then access Instagram® using the vCU instantiated using compute resources in the Seattle SAP and the UPF instantiated using compute resources in the Dallas TAP.

In accordance with one or more embodiments, a computing device, e.g., server blade, of cloud platform 110 can be a virtual computing device, e.g., a virtual server blade, that is based on a hardware configuration that defines the compute, memory and storage, etc. capacity of the device. The hardware configuration can define the number of CPUs, memory size, disk space, etc. for the virtual server blade. An OpenStack® flavor is one non-limiting example of a virtual device configuration definition that can be used in deploying a VNF.

AF 104 can listen to the 5G control plane via SBI and subscriptions to each NF producer and is aware of which NF instance services which UEs 130. In addition, AF 104 has access to each server blade in every server rack 112, 114, 116, 118 and 120 via TMP 102 agent (micro service running on each server) and is able to match and map network activity associated with each NF servicing each UE 130 to the server blades.

By way of one non-limiting example, assume that vCU1 is a VNF deployed as a virtual machine (VM), e.g., a virtual server blade, configured according to a deployment model, such as a large VNF Openstack® flavor that defines, or specifies, the virtual server blade's compute size, e.g., 30 CPUs, 28 GB of memory, 90 GB storage, etc.

Information obtained by module 204 can be maintained in data source 246 by module 248. Module 248 can use information from source 246 and network load and performance information from NWDAF 244 to tune call models that can be used to generate deployment models used to deploy compute resources. Module 204 can define or refine a deployment model used to deploy VNFs on virtual machines (VMs) or containers. By way of a non-limiting example, a deployment model can specify a virtual server blade's compute size.

By way of a non-limiting example, assume that during busy hour vCU1 services 15,000 UEs connected to the 5G network and provides protocol data unit (PDU) sessions (where each session constitutes an end-to-end user plane connectivity between a UE 130 and a DN 140) to UPF1 via control messages from AMF1 and SMF1. AF 104 via TMP 102, plane is able to match and map vCU1 to the specific virtual server blade executing vCU1 (e.g., server blade 4 on server rack 3 in SAP1) and the specific virtual server blade executing UPF1 (e.g., server blade 3 on server rack 3 of SAP1).

Module 248 of AF 104 can use data gathered by module 204 over a period of time to determine the compute resources actually used by vCU1 and adjust vCU1's call model. The actual compute resources used by the vCU1 can be used in dynamically determining deployment model(s) for the vCU1 rather than static models that are based on theoretical data and that tend to play it safe and “over deploy” compute resources as a result.

By way of a non-limiting example, an initial Large VNF Openstack® flavor deployment model used to deploy vCU1 can indicate that vCU1 needs for 30 CPUs and 22 GB of memory. However, resource use 212 information obtained by AF 104 for vCU1 indicates that vCU1 only needs 26 CPUs and 22 GB of memory rather than the 30 CPUs and 22 GB of memory defined by the initial Large VNF Openstack® flavor used to deploy vCU1. AF 104 can refine the Large vCU1 call model and corresponding deployment model for future instantiations of vCU1 and continue to monitor the network to refine and tune the call and deployment models for VCU1.

Module 248 of AF 104 can apply the same technique to each NF in the network to determine actual tuned call models and corresponding deployment models for each NF applicable to each physical, or geographic, location (SAP, TAP, Hubs). Each hardware site (SAP, TAB, hub, etc. ,) at a geographic location, of a number of sites and geographic locations servicing a provider's 5G network, could potentially have differences in the real traffic model based on region differences in subscriber usage patterns. In accordance with embodiments of the present disclosure, AF 104 can define/refine the specifications of virtualized server blades at a given hardware site in a given region to accommodate that region's usage patterns.

When new physical hardware is introduced, AF 104 can provide tuned call and deployment models based on the changing hardware mix. For example, 1 CPU of the new Xeon Sapphire Rapid® has twice the performance of 1 CPU of Xeon Icelake® for a particular type of workload.

Call model tuning, or refining, is expensive and requires considerable compute resources. That is, each NF can have multiple call models associated with different time and/or demand levels, such as and without limitation a daytime/peak demand call model, medium-level demand call model, a nighttime/low demand call model, etc.

Each NF might have high, medium and low demand call models and corresponding high, medium and low level deployment models. To further illustrate, a NF can have its own small, medium, and large VNF OpenStack® flavors, or small, medium, and large CNF deployment Kubernetes® replica sets, as deployment models determined by AF 104 based on high, medium and low demand call models determined for the NF by AF 104.

Conventional approaches derive theoretic, static models tested in a lab using synthetic traffic. Additionally, conventional approaches typically use the largest model possible. Conventional approaches do not have an ability to analyze actual demand levels encountered by each NF—e.g., analyze the number of UEs supported, the number and type of services supported, traffic sent and received—during a period of time to refine call model(s) and corresponding deployment model(s) for each NF.

In accordance with embodiments of the present disclosure, AF 104 can continually update and refine call and deployment models using data obtained by module 204 indicative of actual levels of demand encountered by each NF and define, or refine, corresponding call and deployment models.

In accordance with one or more embodiments, AF 104 can use the data obtained by module 204 to identify quiet network times and use high performance compute resources (e.g., virtual server blades) to perform the call and deployment modeling refinements during these times. This allows existing compute resources to be used for network traffic workloads (e.g., during peak times, which are typically during the day) and for modeling done by AF 104 (e.g., during off-peak times, which typically occur at night). Using existing compute resources in this manner prevents having to buy new compute resources and increases utilization of existing compute resources.

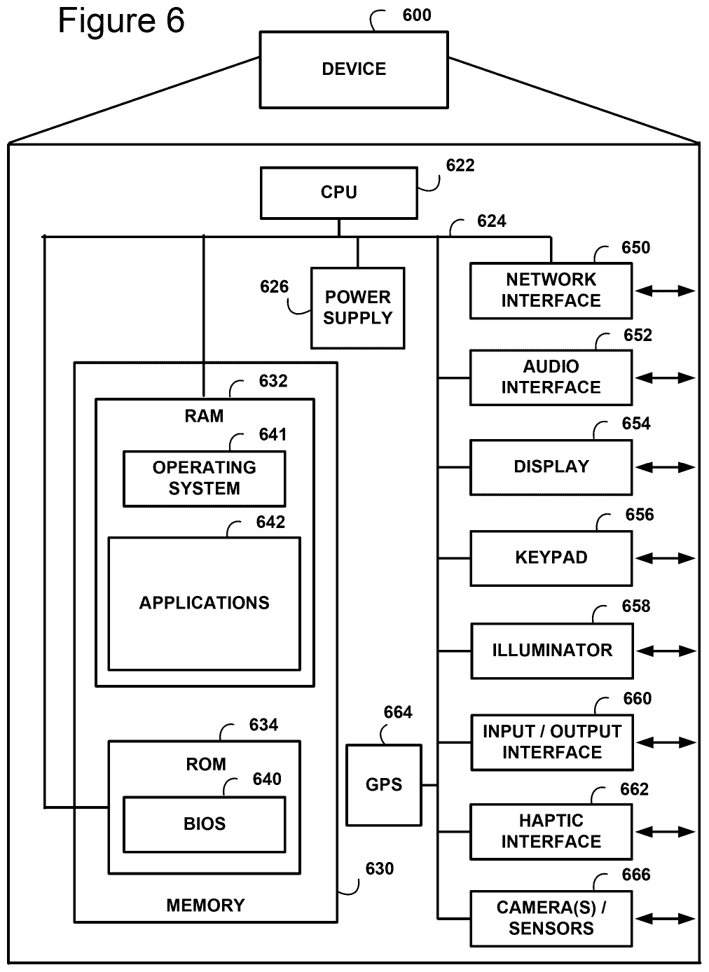

In some exemplary implementations, one or more VNFs, CNFs, NFs, etc. can be implemented on a computing device (such as that described below in connection with FIG. 6). In some exemplary implementations the computing device can be implemented in a cloud computing environment, such as and without limitation cloud platform 110.

FIG. 6 is a block diagram illustrating a computing device showing an example of a client or server device used in the various embodiments of the disclosure.

The computing device 600 may include more or fewer components than those shown in FIG. 6, depending on the deployment or usage of the device 600. For example, a server computing device, such as a rack-mounted server, may not include audio interfaces 652, displays 654, keypads 656, illuminators 658, haptic interfaces 662, GPS receivers 664, or cameras/sensors 666. Some devices may include additional components not shown, such as graphics processing unit (GPU) devices, cryptographic co-processors, artificial intelligence (AI) accelerators, or other peripheral devices.

As shown in FIG. 6, the device 600 includes a central processing unit (CPU) 622 in communication with a mass memory 630 via a bus 624. The computing device 600 also includes one or more network interfaces 650, an audio interface 652, a display 654, a keypad 656, an illuminator 658, an input/output interface 660, a haptic interface 662, an optional global positioning systems (GPS) receiver 664 and a camera(s) or other optical, thermal, or electromagnetic sensors 666, and power supply 626. Device 600 can include one camera/sensor 666 or a plurality of cameras/sensors 666. The positioning of the camera(s)/sensor(s) 666 on the device 600 can change per device 600 model, per device 600 capabilities, and the like, or some combination thereof.

In some embodiments, the CPU 622 may comprise a general-purpose CPU. The CPU 622 may comprise a single-core or multiple-core CPU. The CPU 622 may comprise a system-on-a-chip (SoC) or a similar embedded system. In some embodiments, a GPU may be used in place of, or in combination with, a CPU 622. Mass memory 630 may comprise a dynamic random-access memory (DRAM) device, a static random-access memory device (SRAM), or a Flash (e.g., NAND Flash) memory device. In some embodiments, mass memory 630 may comprise a combination of such memory types. In one embodiment, the bus 624 may comprise a Peripheral Component Interconnect Express (PCIe) bus. In some embodiments, the bus 624 may comprise multiple busses instead of a single bus.

Mass memory 630 illustrates another example of computer storage media for the storage of information such as computer-readable instructions, data structures, program modules, or other data. Mass memory 630 stores a basic input/output system (“BIOS”) 640 (e.g., as part of ROM 634) for controlling the low-level operation of the computing device 600. The mass memory also stores an operating system 641 for controlling the operation of the computing device 600.

Applications 642 may include computer-executable instructions which, when executed by the computing device 600, perform any of the methods (or portions of the methods) described previously in the description of the preceding Figures. In some embodiments, the software or programs implementing the method embodiments can be read from a hard disk drive (not illustrated) and temporarily stored in RAM 632 by CPU 622. CPU 622 may then read the software or data from RAM 632, process them, and store them to RAM 632 again.

The computing device 600 may optionally communicate with a base station (not shown) or directly with another computing device. Network interface 650 is sometimes known as a transceiver, transceiving device, or network interface card (NIC).

The audio interface 652 produces and receives audio signals such as the sound of a human voice. For example, the audio interface 652 may be coupled to a speaker and microphone (not shown) to enable telecommunication with others or generate an audio acknowledgment for some action. Display 654 may any and may also include a touch-sensitive screen arranged to receive input from an object such as a stylus or a digit from a human hand.

Keypad 656 may comprise any input device arranged to receive input from a user. Illuminator 658 may provide a status indication or provide light.

The computing device 600 also comprises an input/output interface 660 for communicating with external devices, using communication technologies, such as USB, infrared, Bluetooth™, or the like. The haptic interface 662 provides tactile feedback to a user of the client device.

The optional GPS transceiver 664 can determine the physical coordinates of the computing device 600 on the surface of the Earth, which typically outputs a location as latitude and longitude values. GPS transceiver 664 can also employ other geo-positioning mechanisms, including, but not limited to, triangulation, assisted GPS (AGPS), E-OTD, CI, SAI, ETA, BSS, or the like, to further determine the physical location of the computing device 600 on the surface of the Earth. In one embodiment, however, the computing device 600 may communicate through other components, provide other information that may be employed to determine a physical location of the device, including, for example, a MAC address, IP address, or the like.

The present disclosure has been described with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, the subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in some embodiments” as used herein does not necessarily refer to the same embodiment, and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms such as “and,” “or,” or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

The present disclosure has been described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure, a non-transitory computer-readable medium (or computer-readable storage medium/media) stores computer data, which data can include computer program code (or computer-executable instructions) that is executable by a computer, in machine-readable form. By way of example, and not limitation, a computer-readable medium may comprise computer-readable storage media, for tangible or fixed storage of data, or communication media for transient interpretation of code-containing signals. Computer-readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer-readable storage media can tangibly encode computer-executable instructions that when executed by a processor associated with a computing device perform functionality disclosed herein in connection with one or more embodiments.

Computer-readable storage media includes, but is not limited to, RAM, ROM, EPROM, EEPROM, flash memory or other solid-state memory technology, CD-ROM, DVD, or other optical storage, cloud storage, magnetic storage devices, or any other physical or material medium which can be used to tangibly store thereon the desired information or data or instructions and which can be accessed by a computer or processor.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

For the purposes of this disclosure the term “user,” “subscriber,” “consumer,” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

In the preceding specification, various example embodiments have been described with reference to the accompanying drawings. However, it will be evident that various modifications and changes may be made thereto, and additional embodiments may be implemented without departing from the broader scope of the disclosed embodiments as set forth in the claims that follow. The specification and drawings are accordingly to be regarded in an illustrative rather than restrictive sense.

1. A method comprising:
obtaining, by an application function (AF), information about network functions (NFs) instantiated as virtual machines (VMs) on compute resources of a cloud platform;
obtaining, by the AF, information about the compute resources;
obtaining, by the AF, information about a plurality of UEs accessing the NFs; and
using, by the AF, the information about the NFs, compute resources of the cloud platform and the plurality of UEs to make an assessment of a workload placement corresponding to the NFs instantiated on the compute resources of the cloud platform.

2. The method of claim 1, obtaining information about the NFs further comprising:
obtaining, by the AF, the information about NFs using a service based interface (SBI) used by the NFs to intercommunicate.

3. The method of claim 1, wherein the information about the NFs comprises one or more of network and service policy information, NF state and metric information and load status information.

4. The method of claim 1, obtaining information about the compute resources further comprising:
obtaining, by the application function (AF), via a tensor mediation plane, the information about the compute resources from a plurality of agents executing on the compute resources of the cloud platform.

5. The method of claim 1, wherein the information about the compute resources comprises one or more of hardware attribute information, resource use information, operational metrics information and network and security information.

6. The method of claim 1, obtaining information about the plurality of UEs accessing the NFs further comprising:
obtaining, by the AF, the information about the plurality of UEs using a service based interface (SBI) used by the NFs to intercommunicate.

7. The method of claim 1, wherein the information about the plurality of UEs accessing the NFs comprises one or more of application and service parametric information, service information, subscription information, slice information, and user identification information.

8. The method of claim 1, further comprising:
updating, by the AF, based on the assessment, the workload placement corresponding to the NFs instantiated on the compute resources of the cloud platform; and
updating, by the AF, registry information to reflect the updated workload placement.

9. The method of claim 1, further comprising:
determining, by a model tuning function of the AF, a level of demand on a respective NF using the information about the respective NF, compute resources of the cloud platform instantiating the respective NF, and each UE of the plurality of UEs serviced by the respective NF;
determining, by the model tuning function of the AF, a call model based on the determined level of demand; and
determining, by the model tuning function of the AF, a deployment model based on the determined call model.

10. The method of claim 9, further comprising:
instantiating, by the AF, the respective NF as a VM on the cloud platform using the determined deployment model.

11. The method of claim 9, further comprising:
instantiating, by the AF, the model tuning function as a VM on the cloud platform.

12. The method of claim 11, the model tuning function instantiation further comprising:
identifying, by the AF, an off-peak time corresponding to high-performance hardware of the cloud platform; and
instantiating, by the AF, the model tuning function as a VM on the high-performance hardware of the cloud platform during the off-peak time.

13. A non-transitory computer-readable storage medium tangibly encoded with computer-executable instructions that when executed by a processor associated with a computing device perform a method comprising:
obtaining, by an application function (AF), information about network functions (NFs) instantiated as virtual machines (VMs) on compute resources of a cloud platform;
obtaining, by the AF, information about the compute resources;
obtaining, by the AF, information about a plurality of UEs accessing the NFs; and
using, by the AF, the information about the NFs, compute resources of the cloud platform and the plurality of UEs to make an assessment of a workload placement corresponding to the NFs instantiated on the compute resources of the cloud platform.

14. The non-transitory computer-readable storage medium of claim 13, obtaining information about the NFs further comprising:
obtaining, by the AF, the information about NFs using a service based interface (SBI) used by the NFs to intercommunicate.

15. The non-transitory computer-readable storage medium of claim 13, wherein the information about the NFs comprises one or more of network and service policy information, NF state and metric information and load status information.

16. The non-transitory computer-readable storage medium of claim 13, obtaining information about the compute resources further comprising:
obtaining, by the application function (AF), via a tensor mediation plane, the information about the compute resources from a plurality of agents executing on the compute resources of the cloud platform.

17. The non-transitory computer-readable storage medium of claim 13, wherein the information about the compute resources comprises one or more of hardware attribute information, resource use information, operational metrics information and network and security information.

18. The non-transitory computer-readable storage medium of claim 13, obtaining information about the plurality of UEs accessing the NFs further comprising:
obtaining, by the AF, the information about the plurality of UEs using a service based interface (SBI) used by the NFs to intercommunicate.

19. The non-transitory computer-readable storage medium of claim 13, wherein the information about the plurality of UEs accessing the NFs comprises one or more of application and service parametric information, service information, subscription information, slice information, and user identification information.

20. A device comprising:
a processor, configured to:
obtain information about network functions (NFs) instantiated as virtual machines (VMs) on compute resources of a cloud platform;
obtain information about the compute resources;
obtain information about a plurality of UEs accessing the NFs; and
using the information about the NFs, compute resources of the cloud platform, and the plurality of UEs, to make an assessment of a workload placement corresponding to the NFs instantiated on the compute resources of the cloud platform.
